(19) United States
(12) Patent Application Publication
(10) Pub. No.: US 2025/0068990 A1
(43) Pub. Date: Feb. 27, 2025

(54) INFORMATION PROCESSING DEVICE, MANUFACTURING HISTORY DISPLAY SYSTEM, MANUFACTURING HISTORY DISPLAY METHOD, AND NON-TRANSITORY COMPUTER READABLE MEDIUM STORING MANUFACTURING HISTORY DISPLAY PROGRAM

(71) Applicant: DENSO CORPORATION, Kariya-city (JP)

(72) Inventors: TATSUYA OKABE, Kariya-city (JP); HARUHIKO NAMIKI, Kariya-city (JP)

(21) Appl. No.: 18/948,084

(22) Filed: Nov. 14, 2024

Related U.S. Application Data
(63) Continuation of application No. PCT/JP2023/014801, filed on Apr. 12, 2023.

(30) Foreign Application Priority Data
May 18, 2022 (JP) 2022-081543

(51) Int. Cl. G06Q 10/063; G06K 7/14; G06Q 50/04

(52) U.S. Cl. CPC G06Q 10/063; G06K 7/1417; G06Q 50/04

(57) ABSTRACT

Disclosed is a technique of technique of processing manufacturing history information. Attachment information attached to a product is read. The attachment information is associated with manufacturing history information of the product. The manufacturing history information associated with the attachment information is acquired from a server based on the read attachment information. The manufacturing history information is displayed on a display unit based on the acquired manufacturing history information. The manufacturing history information is information in which multiple pieces of process information are stored in time series. The multiple pieces of the process information indicate steps of a process related to manufacture of the product. One piece of the process information included in the manufacturing history information is displayed on the display unit, and the process information displayed on the display unit is transitioned in a time series in response to a user operation.

### CROSS REFERENCE TO RELATED APPLICATIONS

The present application is a continuation application of International Patent Application No. PCT/JP2023/014801 filed on Apr. 12, 2023, which designated the U.S. and claims the benefit of priority from Japanese Patent Application No. 2022-081543 filed on May 18, 2022. The disclosures of all the above applications are incorporated herein.

### TECHNICAL FIELD

The present disclosure relates to a technique of processing manufacturing history information.

### BACKGROUND ART

In recent years, management of manufacturing processes of a product, management of a discharge amount of carbon dioxide during manufacture of a product, and the like have been required.

### SUMMARY

According to an aspect of the present disclosure, an information processing device includes a reading unit, an acquisition control unit and a display control unit. The reading unit is configured to read attachment information attached to a product. The attachment information is associated with manufacturing history information of the product. The acquisition control unit is configured to acquire, from a server, the manufacturing history information associated with the attachment information read by the reading unit. The display control unit is configured to display the manufacturing history information acquired by the acquisition control unit on a display unit. The manufacturing history information is information in which multiple pieces of process information are stored in time series. The multiple pieces of the process information indicating steps of a process related to manufacture of the product. The display control unit is configured to display one piece of the process information included in the manufacturing history information on the display unit, and transition the process information displayed on the display unit in a time series in response to a user operation.

### BRIEF DESCRIPTION OF DRAWINGS

The above objects, features, and advantages of the present disclosure will become more apparent from the following detailed description with reference to the accompanying drawings.

FIG. 1 is a schematic configuration diagram of a manufacturing history display system according to an embodiment.

FIG. 2 is a schematic diagram showing a manufacturing process of a product according to the embodiment.

FIG. 3 is a functional block diagram related to display of traceability information of the manufacturing history display system according to the embodiment.

FIG. 4 is a diagram showing a display form of process information on a mobile terminal device according to the embodiment, in which (A) of FIG. 4 is a diagram showing the process information initially displayed on a display unit, and (B) of FIG. 4 is a diagram showing the process information displayed when the display unit on which (A) of FIG. 4 is displayed is swiped in a right direction.

FIG. 5 is a diagram showing a display form of process information including branches on the mobile terminal device according to the embodiment, in which (A) of FIG. 5 shows a case where a process one generation before a latest process includes three transport processes, and (B) of FIG. 5 shows the transport process one generation before.

FIG. 6 is a schematic diagram showing a change in a process in the traceability information according to the embodiment.

FIG. 7 is a flowchart showing a flow of a manufacturing history display process according to the embodiment.

### DETAILED DESCRIPTION

Comparative examples will be described. In recent years, management of manufacturing processes of a product, management of a discharge amount of carbon dioxide during manufacture of a product, and the like have been required.

As a comparative example, a supply chain management method is implemented by a computer to manage a transaction record between traders in a supply chain including multiple traders.

In the comparative example, as an example of a distribution route of white bread, (1) a seed producer delivers seeds of wheat to a wheat farmer, (2) the wheat farmer delivers wheat that grows from the seeds to a wheat flour maker, (3) the wheat flour maker processes the wheat and delivers obtained wheat flour to a bread maker, (4) the bread maker delivers white bread manufactured from the wheat flour to a convenience store, and (5) the convenience store sells the supplied white bread to consumers. In the management method, a consumer can read a QR code (registered trademark) attached to the purchased white bread to view a transaction record such as a raw material, a processing process, and a distribution process.

In the comparative example, the number of steps is relatively small. However, the total number of steps from a raw material to manufacture of a product, including a supply chain, can range from several hundreds to several thousands or more, depending on the product. These processes can take various forms, such as addition, integration, or branching of processes. Consequently, the number of steps in product manufacture may be enormous and the processes may be complicated, making it challenging to accurately grasp them.

In contrast, the present disclosure can provide a technique of processing manufacturing history information, by which processes related to manufacture of a product can be easily grasped.

According to an aspect of the present disclosure, an information processing device includes a reading unit, an acquisition control unit and a display control unit. The reading unit is configured to read attachment information attached to a product. The attachment information is associated with manufacturing history information of the product. The acquisition control unit is configured to acquire, from a server, the manufacturing history information associated with the attachment information read by the reading unit. The display control unit is configured to display the manufacturing history information acquired by the acquisition control unit on a display unit. The manufacturing history information is information in which multiple pieces of process information are stored in time series. The multiple pieces of the process information indicating steps of a process related to manufacture of the product. The display control unit is configured to display one piece of the process information included in the manufacturing history information on the display unit, and transition the process information displayed on the display unit in a time series in response to a user operation.

In this configuration, the manufacturing history information is acquired from the server by reading the attachment information attached to the product, and is displayed on the display unit. The manufacturing history information is information in which the multiple pieces of the process information indicating steps related to the manufacture of the product are stored in time series. The manufacturing history information may have a layer structure (tree structure) including several hundreds, several thousands, or more pieces of the process information and including branching and integration of processes when manufacturing one product. For example, even if the manufacturing history is shown in a figure in order for a person to grasp such a manufacturing history, it is not easy to show an enormous number of steps having the tree structure. Even if the manufacturing history is represented in a diagram, it is difficult for a person to grasp a content of each step from the diagram.

Therefore, according to this configuration, one piece of the process information included in the manufacturing history information is displayed on the display unit, and the process information displayed on the display unit is transitioned in a time series in response to a user operation. Accordingly, the user can grasp a content of each step and a time-series change of the process. Accordingly, the present configuration facilitates grasping the manufacturing process of the product.

In the above-described information processing device, the acquisition control unit may be configured to acquire pieces of the process information from the server. The pieces of the process information corresponds to steps preceding and succeeding a step of one piece of the process information being displayed on the display unit. According to this configuration, the process information that can be displayed on the display unit is acquired from the server in advance, and thus the display of the process information can be speeded up.

In the above-described information processing device, the display control unit may display one piece of the process information corresponding to a latest step of the process as an initial display, transition the process information from the initial display to an upstream side of the process while at least one piece of the process information displayed on the display unit during transition are stored as part of a transition history, and return the process information displayed on the display unit to a downstream side of the process without displaying a piece of the process information which is not part of the transition history.

According to this configuration, when returning the display from the upstream side to the downstream side of the process after displaying the upstream side of the process, a step deviated from a displayed route leading from the latest step to the upstream side of the process is not displayed. Accordingly, this configuration is capable of preventing display of a manufacturing process of another product.

In the above-described information processing device, the display control unit may transition the process information displayed on the display unit in response to a user operation in a left-right direction on the display unit. According to this configuration, the user can easily grasp the process, and operability is improved.

In the above-described information processing device, the display control unit may set a piece of the process information corresponding to a latest step of the process as an initial display, and display, on the display unit, a degree of deviation between one piece of the process information being displayed on the display unit and the piece of the process information corresponding to the latest step. According to this configuration, the user can easily grasp the process being displayed on the display unit.

In the above-described information processing device, the display control unit may display an operation image on the display unit, and the operation image is configured to be operated for returning display on the display unit to the piece of the process information corresponding to the latest step. According to this configuration, the user can easily grasp the process, and the operability is improved.

In the above-described information processing device, the process information includes an amount of carbon dioxide discharged in each step of the process. The display control unit is configured to display at least one of the amount of carbon dioxide discharged in each step of the process and a total amount of carbon dioxide discharged through the process up to a latest step. According to this configuration, a carbon footprint can be traced based on the manufacturing history information, and the user can grasp the amount of carbon dioxide discharged in the manufacturing process.

In the above-described information processing device, the process information displayed on the display unit may include a branch from which processes selectable by a user originate. According to this configuration, the user can easily grasp the process, and the operability is improved.

In the above-described information processing device, the display control unit may display an operation image on the display unit based on the display control unit displaying a piece of the process information related to transport on the display unit. The operation image is configured to be operated for displaying an image indicating a transport route. According to this configuration, the user can grasp the transport route of the product.

In the above-described information processing device, a manner of the user operation for transitioning the display of the process information is changeable. According to this configuration, the operability for the user is improved.

According to an aspect of the present disclosure, a manufacturing history display system includes a server and an information processing device. The server is configured to store manufacturing history information in which multiple pieces of process information are stored in time series. The multiple pieces of the process information indicates steps of a process related to manufacture of a product. The information processing device is configured to read attachment information attached to the product, and the attachment information is associated with the manufacturing history information. The information processing device is configured to acquire the manufacturing history information associated with the attachment information from the server based on reading of the attachment information. The information processing device is configured to display the manufacturing history information on a display unit. The information processing device is configured to display one piece of the process information included in the manufacturing history information acquired from the server on the display unit, and transition the process information displayed on the display unit in a time series in response to a user operation.

According to an aspect of the present disclosure, a manufacturing history display method includes first to third steps. The first step is reading, by a reading unit, attachment information attached to a product. The attachment information is associated with manufacturing history information of the product. The second step is acquiring, by an acquisition control unit, the manufacturing history information associated with the attachment information read by the reading unit from a server. The third step is displaying the manufacturing history information acquired by the acquisition control unit on a display unit. The manufacturing history information is information in which multiple pieces of process information are stored in time series. The multiple pieces of the process information indicates steps of a process related to manufacture of the product. The third step includes displaying one piece of the process information included in the manufacturing history information on the display unit, and transitioning the process information displayed on the display unit in a time series in response to a user operation.

According to an aspect of the present disclosure, a manufacturing history display program causes a computer provided in an information processing device to function as a reading unit, an acquisition control unit and a display control unit. The reading unit is configured to read attachment information attached to a product. The attachment information is associated with manufacturing history information of the product. The acquisition control unit is configured to acquire, from a server, the manufacturing history information associated with the attachment information read by the reading unit. The display control unit is configured to display the manufacturing history information acquired by the acquisition control unit on a display unit. The manufacturing history information is information in which multiple pieces of process information are stored in time series. The multiple pieces of the process information indicating steps of a process related to manufacture of the product. The display control unit is configured to display one piece of the process information included in the manufacturing history information on the display unit, and transition the process information displayed on the display unit in a time series in response to a user operation.

According to the present disclosure, the steps related to manufacture of the product can be easily grasped.

Hereinafter, an embodiment of the present disclosure will be described with reference to the drawings. The embodiment to be described below is an example of a case where the present disclosure is implemented, and the present disclosure is not limited to the specific configuration to be described below. For the implementation of the present disclosure, specific configurations according to the embodiments may be appropriately adopted.

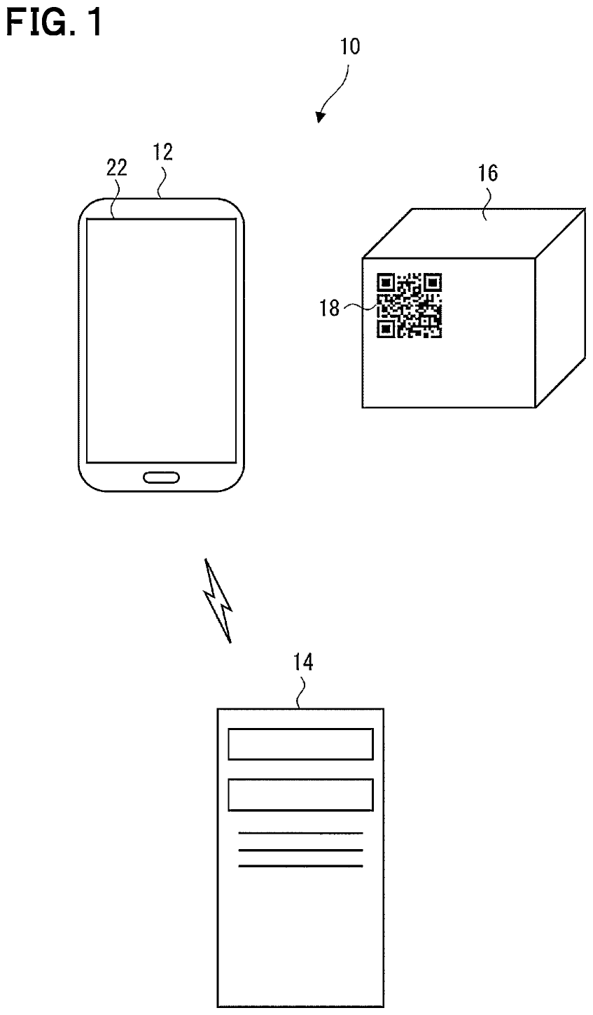

FIG. 1 is a schematic configuration diagram of a manufacturing history display system 10 according to the present embodiment. The manufacturing history display system 10 according to the present embodiment includes a mobile terminal device 12 and a server 14.

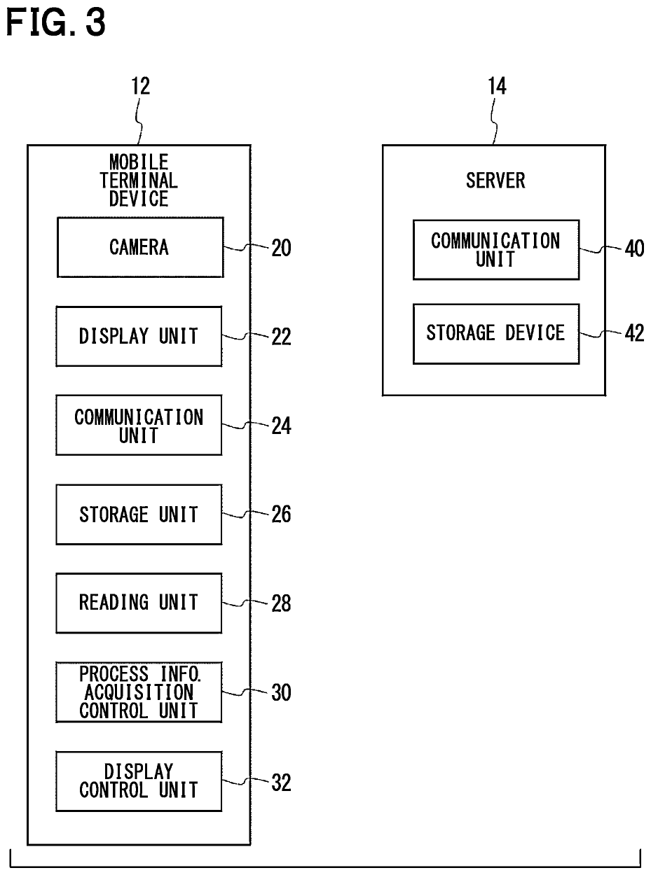

The mobile terminal device 12 is an information processing device such as a smartphone or a tablet terminal including a camera 20 (see FIG. 3) and a display unit 22 such as a touch panel display. The mobile terminal device 12 is not limited thereto, and as long as the mobile terminal device 12 is capable of reading attachment information 18 (for example, a QR code) of a product 16 to be described below and displaying process information, the mobile terminal device 12 may be a dedicated device for displaying the process information, and a reading device incorporated into an existing manufacturing device for manufacturing the product 16 may be used.

The mobile terminal device 12 images the attachment information 18 attached to the product 16 by the camera 20, and reads a recorded content of the attachment information 18.

The attachment information 18 is an information code associated with manufacturing history information of the product 16 and attached to the product 16. The attachment information 18 according to the present embodiment is a QR code as an example, but is not limited thereto, and may be an information code such as another two-dimensional code or a one-dimensional code such as a bar code. In the attachment information 18, both or one of an inquiry destination (an IP address or a URL of the server 14) of the manufacturing history information of the product 16, to which the attachment information 18 is attached, and individual information of the product is recorded. The manufacturing history information is also information for enabling tracing of a process from manufacture to consumption of the product 16, and is referred to as traceability information in the following description.

The traceability information is information in which multiple pieces of process information indicating steps of a process related to the manufacture of the product 16 are recorded in time series, and is stored in the server 14. The product 16 is a raw material, a component manufactured by processing the raw material, and a final product or the like obtained by combining the multiple components, and has various forms in the manufacturing process thereof.

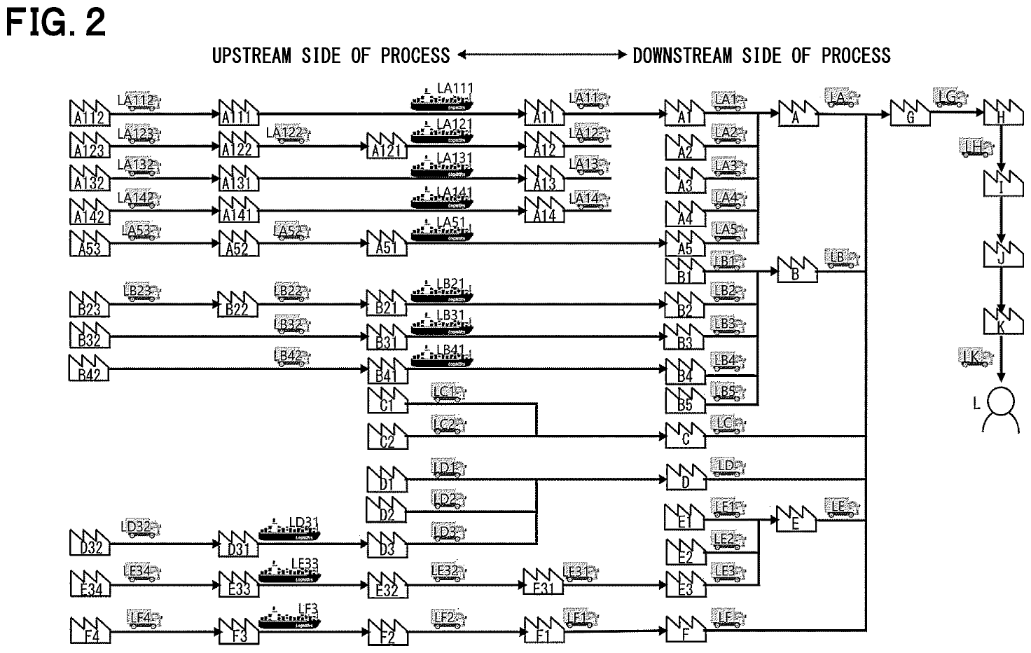

FIG. 2 is a schematic diagram showing a manufacturing process of an in-vehicle battery as the final product, for example. In the following description, an upstream side of the process is also referred to as a preceding process, and a downstream side of the process is also referred to as a succeeding process. As shown in FIG. 2, in order to manufacture the in-vehicle battery, various processes, also including a supply chain, such as supplying of various raw materials, processing into components, processing from raw materials into components, assembling from components to final products, transport of raw materials and components, and an inspection of components and final products are required. There are also various forms such as addition of processes, integration of processes, and branching of processes. The integration of the processes refers to a form in which multiple preceding processes are set as one succeeding process. The branching of the process refers to a form in which one preceding process branches to multiple succeeding processes.

More specifically, in FIG. 2, lithium-containing salt water is delivered from a facility A112 to a facility 111 by a vehicle LA112, delivered to a facility A11 by a ship LA111, and then delivered by a vehicle LA11 to a facility A1. Cobalt ore extracted from a mine is delivered by a vehicle LA123 from a facility A123 to a facility A122 where the cobalt ore is ore dressed and smelted. The cobalt ore is delivered by a vehicle LA122 to a facility A121 where the cobalt ore is refined, and then delivered by a ship LA121 to a facility A12 where cobalt precursor is obtained from the cobalt ore. The cobalt precursor is delivered by a vehicle LA12 to the facility A1. Nickel ore extracted from a mine is delivered by a vehicle LA132 from a facility A132 to a facility A131 where the nickel ore is ore dressed and smelted. The nickel ore is delivered by a ship LA131 to a facility A13 where nickel precursor is obtained from the nickel ore. The nickel precursor is delivered by a vehicle LA13 to the facility A1. Manganese ore extracted from a mine is delivered by a vehicle LA142 from a facility A142 to a facility A141 where the manganese ore is ore dressed and smelted. The manganese ore is delivered by a ship LA141 to a facility A14 where manganese precursor is obtained from the manganese ore. The manganese precursor is delivered by a vehicle LA14 to the facility A1. In the facility A1, a PEAM (i.e., positive-electrode active material) is produced from the delivered materials, and then delivered by a vehicle LA1 to a facility A. Bauxite ore extracted from a mine is delivered by a vehicle LA53 from a facility A53 to a facility A52 where alumina is extracted from the bauxite. The alumina is delivered by a vehicle A52 to a facility A51 where aluminum bae metal is produced from the alumina. The aluminum base metal is delivered by a ship LA51 from the facility A51 to a facility A5 where aluminum foil is produced from the aluminum base metal. The PEAM, a conductive material, a binder, an auxiliary material NMP, and the aluminum foil are delivered, respectively, by vehicles LA1, LA2, LA3, LA4 and LA5 from facilities A1, A2, A3, A4 and A5 to a facility A where a positive electrode is manufactured therefrom.

Natural graphite ore is delivered by a vehicle LB23 from a facility B23 to a facility B22 where the natural graphite ore is ore-dressed, and the ore is delivered by a vehicle LB22 to a facility B21 where the natural graphite ore is processed. The natural graphite ore is delivered by a ship LB21 to a facility B2 where a NEAM natural graphite (i.e., negative-electrode active material natural graphite) is produced from the natural graphite ore. Coal-tar crude oil is delivered by a vehicle LB32 from a facility B32 to a facility B31 where coke is produced from the coal-tar crude oil, and the coke is delivered by a ship LB31 to a facility B3 where a NEAM artificial graphite (i.e., negative-electrode active material artificial graphite) is produced from the coke. Copper ore extracted from a mine is delivered by a vehicle LB42 from a facility B42 to a facility B41 where a copper raw material is produced from the copper ore, and the cupper raw material is delivered by a ship LB 41 to a facility B4 where a electrolytic copper foil is produced from the copper raw material. An auxiliary material NMP, the NEAM natural graphite, the NEAM artificial graphite, the electrolytic copper foil and a binder are delivered, respectively, by vehicles LB1, LB2, LB3, LB4 and LB5 from facilities B1, B2, B3, B4 and B5 to a facility B where a negative electrode is manufactured therefrom.

Polyethylene and polypropylene delivered by a vehicle LC1 from a facility C1, and Al₂O₃ delivered by a vehicle LC2 from a facility C2 are delivered to a facility C where a separator is produced therefrom.

Lithium-containing salt water is delivered by a vehicle LD32 from a facility D32 to a facility D31 where lithium carbonate and lithium hydroxide are produced, and the lithium carbonate and lithium hydroxide are delivered by a ship LD31 to a facility D3 where LIPF6 is produced. Carbonate solution, additives and the LIPF6 are delivered, respectively, by vehicles LD1, LD2 and LD3 from facilities D1, D2 and D3 to a facility D where an electrolytic solution is produced therefrom.

Bauxite ore extracted from a mine is delivered by a vehicle LE34 from a facility E34 to a facility E33 where alumina is extracted from the bauxite. The alumina is delivered by a ship LE33 to a facility E32 where aluminum bae metal is produced from the alumina. The aluminum base metal is delivered by a vehicle LE32 from the facility E32 to a facility E31 where an aluminum plate is produced from the aluminum base metal, and the aluminum plate is delivered by a vehicle LE31 to a facility E3 where an aluminum component is produced. A copper component, a resin component and the aluminum component are delivered, respectively, by vehicles LE1, LE2 and LE3 to a facility E where a sub-assembly is manufactured therefrom.

Bauxite ore extracted from a mine is delivered by a vehicle LF4 from a facility F4 to a facility F3 where alumina is extracted from the bauxite. The alumina is delivered by a ship LF3 to a facility F2 where aluminum bae metal is produced from the alumina. The aluminum base metal is delivered by a vehicle LF2 from the facility F2 to a facility F1 where an aluminum case is produced from the aluminum base metal.

The positive electrode, the negative electrode, the separator, the electrolytic solution, the sub-assembly and the aluminum case are delivered, respectively, by vehicles LA, LB, LC, LD, LE and LF to a facility G where an assembly is manufactured. The assembly is delivered by a vehicle LG to a facility H where an activation test of the assembly is performed. The assembly is delivered by a vehicle LH to a facility I where stacking is performed, and delivered to a facility H where welding of bas-bars is performed. Then, a battery for a vehicle is produced in a facility K, and the battery is delivered by a vehicle LK to a customer to be used as the in-vehicle battery.

Although not shown in FIG. 2, a process of supplying raw materials, a process of processing components, or the like may include a branch to a manufacturing process of another product 16. Here, the other product 16 referred to here includes not only the product 16 of the own company, but also the product 16 of another company. The traceability information may include a series of processes from collecting and recycling the product 16 which has been used to manufacture of the product 16 by the recycled material.

The server 14 accumulates data related to the manufacturing process of each product 16 as the process information by sequentially adding the data to the traceability information in time series. Each piece of the process information includes information such as a content of a process, a registration date and time of the process information, a product name of the product 16, information related to the supply chain (a company name, a manufacturing base name, and position information of manufacturing base location), and a transport route of the product 16. When the traceability information of the server 14 is accumulated, a data falsification prevention method such as a blockchain other than a normal database may be used.

Each piece of the process information includes information on when and where the corresponding process is performed, a discharge amount of carbon dioxide (CO₂) in the corresponding process, and the like. The amount of carbon dioxide to be discharged includes not only the amount in processes directly involved in the manufacture but also the amount of carbon dioxide discharged by a transportation device such as ships and trucks due to the transportation of the product 16 and the amount of carbon dioxide discharged in an indirect section that is not directly involved in the manufacture. Accordingly, tracing of a carbon footprint based on the traceability information is implemented.

As an example of management of the traceability information according to the present embodiment, blockchain technology is used for the purpose of preventing falsification of the traceability information. Specifically, for example, the server 14 generates a hash value of data related to each process of the product 16, sets the data (hash value) as one block, and performs an incorporation process of a block to be connected at an end of the blockchain. Then, according to a progress of the manufacturing processes of the product 16, the server 14 repeats the calculation of the hash value reflecting the manufacturing processes up to a corresponding process. As a result, the hash value provided for each of the manufacturing processes of the product 16 is a value (Merkle route) reflecting all the manufacturing processes up to the corresponding process. Accordingly, the traceability information is stored using the blockchain to be associated with the process information of the product 16. The server 14 according to the present embodiment generates the attachment information 18 in which the hash value is recorded together with an inquiry destination of the traceability information of the product 16 to which the attachment information 18 is attached, and outputs the attachment information 18 in a form that can be attached to the product 16.

The QR code that is the attachment information 18 is attached to each product 16 of each process. In addition to being directly attached to the product 16, the attachment information 18 may be attached to a container containing the product 16, a tag managing the product 16, or the like. The attachment information 18 is newly generated by the server 14, for example, when multiple processes (A11 to A14) are integrated as in a process A1 in FIG. 2 or one process is branched. In this case, a manufacturer of the product 16 for which the attachment information 18 is newly generated outputs the QR code to a paper medium or the like and attaches the QR code to each product 16. New generation of the attachment information 18 is not limited to a case where the integration or the branching of the processes occurs, and may be appropriately performed.

The mobile terminal device 12 images the attachment information 18 attached to the product 16 by the camera 20, and acquires the traceability information indicating a manufacturing process of the product 16 from the server 14 based on a recorded content (inquiry destination) obtained by reading the attachment information 18. Then, the mobile terminal device 12 displays the traceability information acquired from the server 14 on the display unit 22.

Here, a manufacturing history indicated by the traceability information has a layer structure (tree structure) including several hundreds, several thousands, or more pieces of the process information and including the branching and the integration of processes when manufacturing one product 16. In order for a person to grasp such a manufacturing history, for example, even if the manufacturing history is as shown in FIG. 2, it is not easy to show an enormous number of processes having the tree structure. Even if the manufacturing history is represented in a diagram, it is difficult for a person to grasp the content of each process from the diagram. Further, even in the case shown in the diagram, it is very difficult for a person to grasp the manufacturing history and the like.

Here, the mobile terminal device 12 according to the present embodiment displays a piece of the process information included in the traceability information on the display unit 22, and transitions the process information displayed on the display unit 22 in a time series when a user operates the display unit 22. Accordingly, the user can grasp the content of each process and a time-series change of the process. Accordingly, the manufacturing process of the product 16 can be easily grasped via the mobile terminal device 12 according to the present embodiment. The mobile terminal device 12 according to the present embodiment does not have, for example, a function of displaying a diagram showing the entire traceability information as shown in FIG. 2.

FIG. 3 is a functional block diagram related to display of the traceability information of the manufacturing history display system 10.

The mobile terminal device 12 includes a communication unit 24, a storage unit 26, a reading unit 28, a process information acquisition control unit 30, and a display control unit 32 in addition to the camera 20 and the display unit 22.

The camera 20 has an imaging function, and images the attachment information 18 attached to the product 16 in the present embodiment.

The display unit 22 is, for example, a touch panel display, displays various kinds of data, and receives an operation on the mobile terminal device 12 from the user.

The communication unit 24 transmits and receives information to and from another information processing device such as the server 14. The communication unit 24 according to the present embodiment transmits and receives information to and from the server 14 via a communication unit 40 provided in the server 14. A storage device 42 provided in the server 14 stores the traceability information of the product 16.

The storage unit 26 stores a program (application) related to reading of the attachment information 18 and display of the process information, and various kinds of data such as the process information acquired from the server 14.

The reading unit 28 reads the attachment information 18 (QR code) imaged by the camera 20. Then, the reading unit 28 performs a decoding process for decoding the information recorded in the read attachment information 18.

The process information acquisition control unit 30 acquires the traceability information, which is associated with the attachment information 18 read by the reading unit 28, from the server 14 via the communication unit 24. The process information acquisition control unit 30 according to the present embodiment does not acquire all pieces of the traceability information from the server 14 at a time, but sequentially acquires pieces of the process information preceding and succeeding of a piece of the process information being displayed on the display unit 22 from the server 14. The process information acquired from the server 14 is stored in the storage unit 26. Accordingly, it is possible to shorten a time required for the display.

The display control unit 32 controls the display unit 22 to display various images. The display control unit 32 according to the present embodiment displays, on the display unit 22, the traceability information acquired by the process information acquisition control unit 30. The display control unit 32 according to the present embodiment displays, on the display unit 22, each piece of the process information included in the traceability information, and causes the process information displayed on the display unit 22 to transition in time series in response to an operation performed by the user.

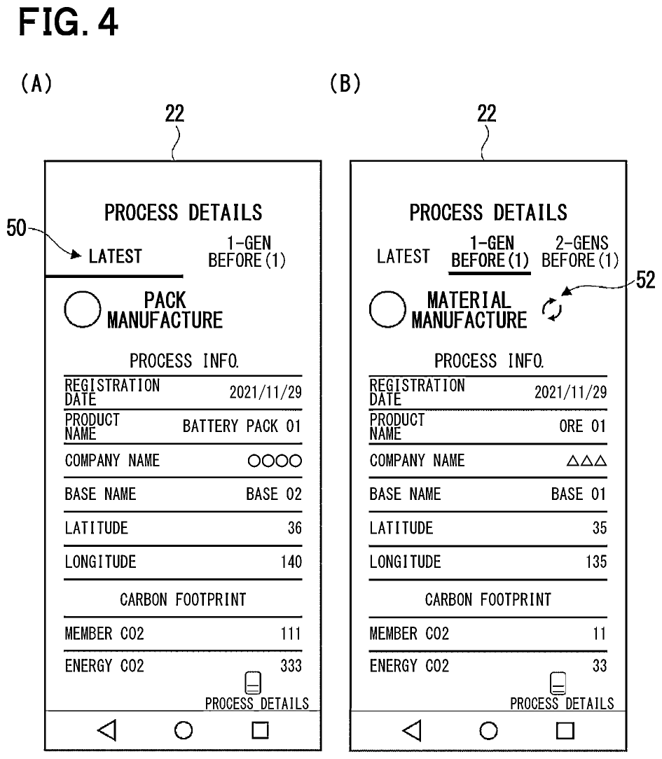

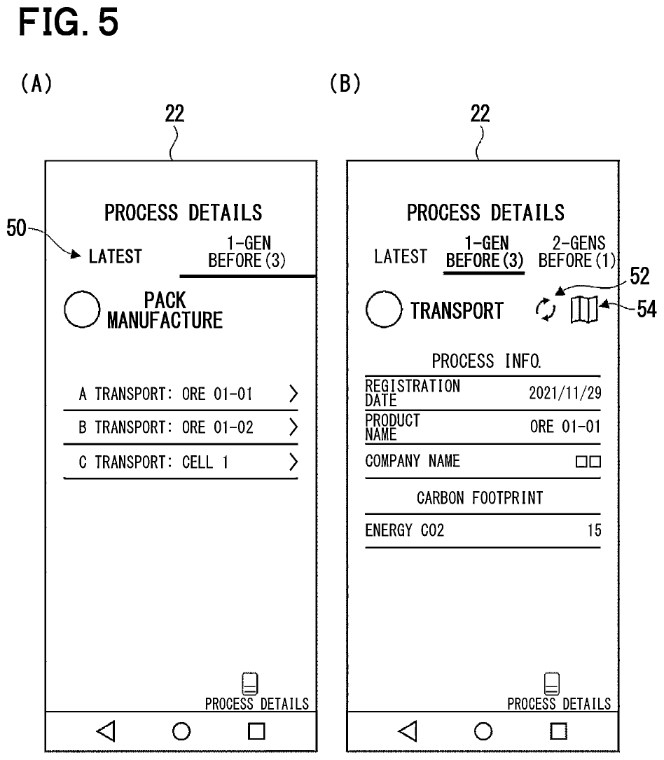

Next, a display form of the process information on the mobile terminal device 12 will be described with reference to FIGS. 4 and 5. The user grasps the manufacturing process of the product 16 by viewing the process information displayed as shown in FIGS. 4 and 5. When the mobile terminal device 12 reads the attachment information 18 and acquires the process information from the server 14, an application (hereinafter, referred to as a “display application”) installed in the mobile terminal device 12 in advance is activated, and the acquired process information is displayed on the display unit 22.

(A) of FIG. 4 is a diagram showing the process information that is initially displayed on the display unit 22 by reading the attachment information 18. (B) of FIG. 4 is a diagram showing the process information displayed when the display unit 22 on which (A) of FIG. 4 is displayed is swiped in a right direction.

As shown in (A) of FIG. 4, the display control unit 32 sets the latest process information as an initial display. For example, when the attachment information 18 of the product 16 is read in a case where a manufacturing process G (assembly) is the latest process at a current time in FIG. 2, the process information of the manufacturing process G is first displayed on the display unit 22 as the latest process information. Then, when the user performs swiping in the right direction, a process one generation before the latest process information, that is, a process immediately preceding (on the upstream side of) the latest process is displayed as shown in (B) of FIG. 4. As described above, in the present embodiment, as an example, the process information on the upstream side is transitioned and displayed by swiping the display unit 22 in the right direction. On the other hand, by swiping the display unit 22 in a left direction, the process information on the downstream side is transitioned to and displayed. Even when the swiping is performed in the left direction in a state where the latest process information is displayed, there is no transition in the displayed process information. Although the swiping in the right direction allows transition to a preceding process, and the swiping in the left direction allows transition to a succeeding process, which is based on results of experiments related to usability and matches feelings of many users, and the direction may be reversed or changed to an upper-lower direction.

In this manner, the display control unit 32 transitions the process information displayed on the display unit 22 in response to the operations in the left and right directions performed on the display unit 22 by the user. Accordingly, the user can easily grasp the process, and operability is improved. In the present embodiment, the process information displayed on the display unit 22 is transitioned by swiping the display unit 22, but the present disclosure is not limited thereto, and for example, an arrow button for causing the display of the process to transition may be displayed on the display unit 22, and the displayed process information may be transitioned by clicking the arrow button.

The display control unit 32 according to the present embodiment sets the latest process information as the initial display and displays, on the display unit 22, a degree of deviation between the process information being displayed on the display unit 22 and the latest process information, in order to make the user easily grasp the process being displayed on the display unit 22.

The degree of deviation is displayed as “generation” in a generation display field 50 shown in FIG. 4. In (A) of FIG. 4, since the latest process information is displayed, “latest” in the generation display field 50 is highlighted. Since (B) of FIG. 4 shows the process information one generation before the latest, “one generation before (1)” in the generation display field 50 is highlighted. Further, when the user performs swiping in the right direction in the display state of (B) of FIG. 4, the process information two generations before is displayed on the display unit 22, and “two generations before (1)” in the generation display field 50 is highlighted.

Further, as shown in (B) of FIG. 4, the display control unit 32 displays, on the display unit 22, an operation image (hereinafter, referred to as a “latest-process-information return button”) 52 for returning the display on the display unit 22 to the latest process information. Accordingly, even when the process information on the upstream side is displayed, the latest process information is displayed on the display unit 22 by operating (clicking) the latest-process-information return button 52, and thus the user can easily grasp the process, and the operability is improved. The latest-process-information return button 52 is not displayed when the latest process information is being displayed on the display unit 22.

The display unit 22 displays “pack manufacturing” or “material manufacturing” which is a name of the displayed process information, date and time of registration in the traceability information as the detailed process information, a product name of the product 16, a name of a company manufacturing the product 16, a base name which is a manufacturing place, latitude and longitude indicating a location of the base, information of used material, processing information, due diligence, a carbon footprint, and the like.

At least one of the amount of carbon dioxide (CO₂) discharged in each of the steps and a total amount of carbon dioxide discharged through the process up to the latest step is displayed on the display unit 22. Accordingly, the carbon footprint is traced, and the user can grasp the amount of carbon dioxide discharged in the manufacturing process.

In the mobile terminal device 12 according to the present embodiment, information that cannot be displayed on one screen of the display unit 22 may be displayed by swiping in the upper-lower direction or an accordion display.

Next, acquisition of the process information from the server 14 by the process information acquisition control unit 30 according to the present embodiment will be described. As described above, the process information acquisition control unit 30 acquires the process information before and after the process information displayed on the display unit 22 from the server 14.

When acquiring the latest process information, the process information acquisition control unit 30 according to the present embodiment simultaneously acquires the process information one generation before. Then, as shown in (B) of FIG. 4, when the process information one generation before is displayed on the display unit 22, the process information acquisition control unit 30 acquires the process information two generations before, which is the next process information on the upstream side, from the server 14. Accordingly, when the process information two generations before is to be displayed on the display unit 22, since the mobile terminal device 12 has already acquired the process information, the process information two generations before is displayed on the display unit 22 together with the swiping in the right direction. In a state in which the process information one generation before is displayed on the display unit 22, since the mobile terminal device 12 has already acquired the latest process information, the latest process information is displayed on the display unit 22 together with the swiping in the left direction.

As described above, the mobile terminal device 12 acquires the process information before and after the process information being displayed on the display unit 22 from the server 14. Accordingly, the mobile terminal device 12 acquires the process information that may be displayed on the display unit 22 from the server 14 in advance, and thus the display of the process information can be speeded up.

Next, a case where there is a branch when the display is transitioned from the succeeding process to the preceding process will be described with reference to FIG. 5. The branch referred to here means a case where multiple processes on the upstream side are integrated into one process on the downstream side in an actual process.

(A) of FIG. 5 shows a case where the processes one generation before the latest process are three transport processes. In such a case, “A transport”, “B transport”, and “C transport” are displayed as a branch for selecting one of the three transport processes together with the product 16 (product name) to be transported. When the user selects one of these, a transport process that is one generation before is displayed on the display unit 22 as shown in (B) of FIG. 5.

As described above, since the process information to be displayed on the display unit 22 includes the branch of the processes that can be selected by the user, the user can easily grasp the processes and the operability is improved. In the process including the branch, the number of branches is displayed in “( )” such as “one generation before (3)” in the generation display field 50 in FIG. 5. A process without the branch is indicated as “(1)”. Accordingly, the user can easily recognize whether the displayed process information is a branched process.

When a process is included in which a branch is present before or after the process information being displayed on the display unit 22, the process information acquisition control unit 30 acquires all the branch processes from the server 14. That is, in the example of (A) of FIG. 5, all of the process information including the “A transport”, the “B transport”, and the “C transport” is acquired from the server 14. Accordingly, the process information can be displayed on the display unit 22 at high speed regardless of the process selected by the user.

When the transport process is displayed on the display unit 22, the display control unit 32 displays, on the display unit 22, an operation image (hereinafter, referred to as a “transport-route display button”) 54 for displaying an image indicating the transport route. When the user operates (clicks) the transport-route display button 54, the transport route in the corresponding transport process is displayed together with map information on the display unit 22. Accordingly, the user can grasp the transport route of the product 16.

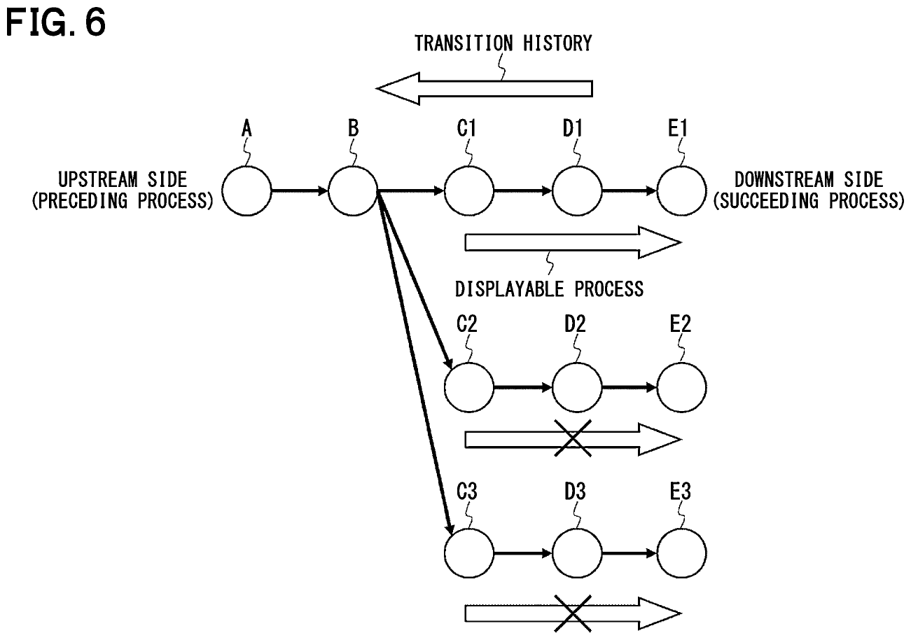

Next, a case where the display is transitioned from the downstream side to the upstream side of the process and returned to the downstream side of the process again will be described with reference to FIG. 6.

As shown in FIG. 6, there is no branch in the transition of the display from the downstream side to the upstream side of the process, but a branch (processes C1, C2, and C3) may occur during the transition from the upstream side to the downstream side. Such a branch occurs, for example, when the procured raw material is transported separately for manufacturing multiple different products 16, and a process of procuring the raw material may be common as the manufacturing process of the product 16 different from the original product 16 in the traceability information.

When such a branch is included in the manufacturing history information, for example, when the display is transitioned from the downstream side to the upstream side of the process and is returned to the downstream side of the process again, a branch different from the manufacturing process of the original product 16 may be selected and the manufacturing process of the other product 16 may be displayed on the display unit 22. The other product 16 may include the product 16 of another company different from the own company.

Referring to FIG. 6, the manufacturing process of the original product 16 being viewed by the user is processes A to B to C1 to E1. When the user returns the display to the downstream side of the process C1 after displaying the upstream side of the process B, if the process C2 or the process C3 can be selected in the branch after the process B, the user may view a route of the manufacturing process of the other product 16.

When the manufacturing process of the other product 16 is displayed, the user may not be able to view the manufacturing process of the product 16 which is originally desired to be displayed, and may unnecessarily view the manufacturing process of the product 16 of the other company. Therefore, it is necessary to prevent viewing of such a manufacturing process of another product 16.

Therefore, the manufacturing history display system 10 according to the present embodiment stores a transition history of the process information displayed on the display unit 22. The transition history is stored in the mobile terminal device 12 or the server 14. Then, when the display control unit 32 sets the latest process information as the initial display, transitions the display from the downstream side to the upstream side of the process, and returns the display to the downstream side of the process again, the process information different from that in the transition history is not displayed on the display unit 22.

That is, when the display is returned to the process on the downstream side of the process B in FIG. 6 after the process on the upstream side is displayed, the user cannot select the display of the processes C2 and C3, and only the process on the downstream side of the process C1 is displayed. That is, when returning the display from the upstream side to the downstream side of the process after displaying the upstream side of the process, the mobile terminal device 12 does not display a process different from that in a display route leading to the upstream side of the process, and displays the same process as that in the display route.

Therefore, in the manufacturing history display system 10 according to the present embodiment, it is possible to prevent a manufacturing process of another product 16 different from the original product 16 from being displayed. By storing the transition history, the user can search for the process information to be displayed on the display unit 22 at high speed.

Further, in the mobile terminal device 12 according to the present embodiment, the user can change, by a setting, an operation manner for causing the display of the process information to transition.

When the setting is changed, for example, when swiping in the right direction is performed, the process information on the upstream side may be displayed, and when swiping in the left direction is performed, the process on the downstream side may be displayed. Further, the process information displayed on the display unit 22 may be transitioned in the upper-lower direction by swiping in the upper-lower direction. Instead of a gesture operation such as the swiping, an arrow button may be displayed, and the process information displayed on the display unit 22 may be transitioned by operating the arrow button. Accordingly, an operation manner can be changed according to a generation or preference of the user, and the operability for the user is improved.

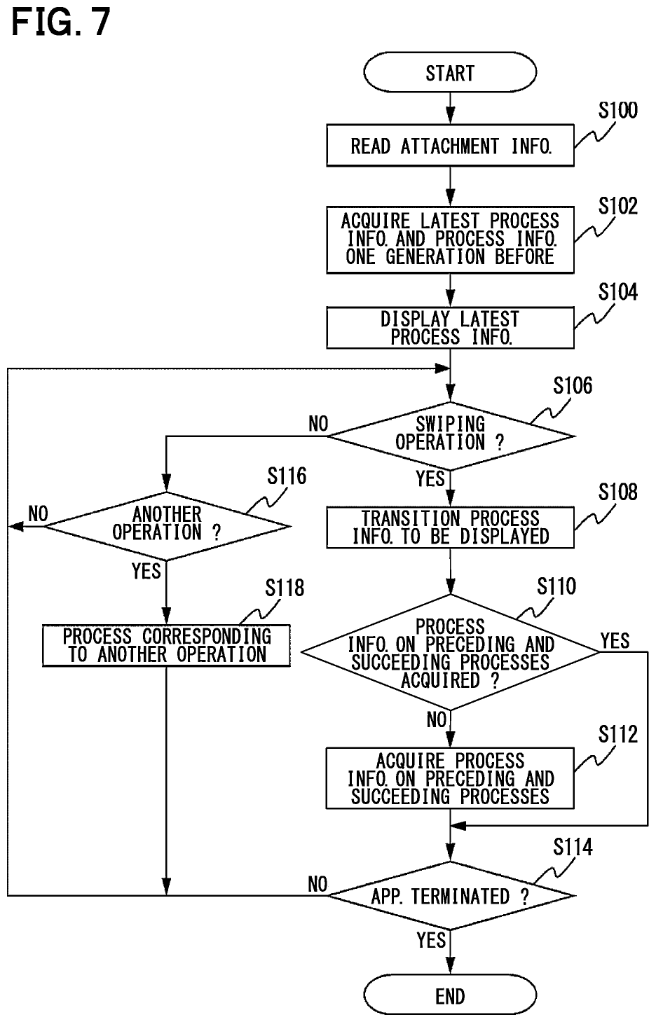

FIG. 7 is a flowchart showing a flow of a manufacturing history display process executed by the mobile terminal device 12. The manufacturing history display process is executed by a program (display application) stored in a recording medium such as the storage unit 26 provided in the mobile terminal device 12. A method corresponding to the program is executed by executing the program.

First, in step S100, the mobile terminal device 12 images the attachment information 18 of the product 16 with the camera 20, and the reading unit 28 reads the content of the attachment information 18.

In a next step S102, the process information acquisition control unit 30 acquires the latest process information and the process information one generation before from the server 14 via the communication unit 24, and stores the latest process information and the process information one generation before into the storage unit 26.

In a next step S104, the display control unit 32 displays the latest process information on the display unit 22.

In a next step S106, it is determined whether a swiping operation is performed on the display unit 22. When the determination is affirmative, the process proceeds to step S108. When the determination is negative, the process proceeds to step S116.

In step S108, the display control unit 32 causes the process information displayed on the display unit 22 to transition in response to the swiping operation.

In a next step S110, the process information acquisition control unit 30 determines whether the process information of the preceding process or the succeeding process of the process information being displayed on the display unit 22 is acquired. When the determination is affirmative, the process proceeds to step S114. On the other hand, in a case of a negative determination, the process proceeds to step S112.

In step S112, the process information acquisition control unit 30 acquires the process information of the preceding process or the succeeding process of the process information being displayed on the display unit 22 from the server 14, and stores the process information of the preceding process or the succeeding process of the process information into the storage unit 26.

In a next step S114, it is determined whether an operation for terminating the display application is performed. When the determination is affirmative, the display application is terminated. When the determination is negative, the process returns to step S106.

In step S116 to which the process proceeds in the case of the negative determination in step S106, it is determined whether an operation other than the swiping operation is performed. When the determination is affirmative, the process proceeds to step S118. When the determination is negative, the process returns to step S106. The other operation includes, for example, a selection of a branch, an operation on the latest-process-information return button 52, an operation on the transport-route display button 54, and a setting change operation.

In step S118, a process corresponding to the other operation is performed, and the process returns to step S106.

Although the present disclosure has been described with reference to the above embodiment, the technical scope of the present disclosure is not limited to the scope described in the above embodiment. Various modifications or improvements can be made to the above embodiment without departing from the gist of the disclosure, and the modifications or improvements are also included in the technical scope of the present disclosure.

For example, in the above-described embodiment, a form has been described in which the display unit 22 displays each piece of the process information, but the present disclosure is not limited thereto, and a form may be adopted in which two or more pieces of the process information are simultaneously displayed on the display unit 22. In the case of this form, the mobile terminal device 12 also has the same function as that of the above-described embodiment. For example, the process information acquisition control unit 30 acquires the process information before and after the process information being displayed on the display unit 22 from the server 14. When the display control unit 32 causes the display to transition from the downstream side to the upstream side of the process, and returns the display to the downstream side of the process again, the process information different from that in the transition history is not displayed on the display unit 22.

What is claimed is:

1. An information processing device comprising:
a reading unit configured to read attachment information attached to a product, the attachment information being associated with manufacturing history information of the product;
an acquisition control unit configured to acquire, from a server, the manufacturing history information associated with the attachment information read by the reading unit; and
a display control unit configured to display the manufacturing history information acquired by the acquisition control unit on a display unit, wherein
the manufacturing history information is information in which multiple pieces of process information are stored in time series, the multiple pieces of the process information indicating steps of a process related to manufacture of the product, and
the display control unit is configured to
display one piece of the process information included in the manufacturing history information on the display unit, and
transition the process information displayed on the display unit in a time series in response to a user operation.

2. The information processing device according to claim 1, wherein
the acquisition control unit is configured to acquire pieces of the process information from the server, the pieces of the process information corresponding to steps preceding and succeeding a step of one piece of the process information being displayed on the display unit.

3. The information processing device according to claim 1, wherein
the display control unit is configured to
display one piece of the process information corresponding to a latest step of the process as an initial display,
transition the process information from the initial display to an upstream side of the process while at least one piece of the process information displayed on the display unit during transition are stored as part of a transition history, and
return the process information displayed on the display unit to a downstream side of the process without displaying a piece of the process information which is not part of the transition history.

4. The information processing device according to claim 1, wherein
the display control unit is configured to transition the process information displayed on the display unit in response to a user operation in a left-right direction on the display unit.

5. The information processing device according to claim 1, wherein
the display control unit is configured to
set a piece of the process information corresponding to a latest step of the process as an initial display, and
display, on the display unit, a degree of deviation between one piece of the process information being displayed on the display unit and the piece of the process information corresponding to the latest step.

6. The information processing device according to claim 5, wherein
the display control unit is configured to display an operation image on the display unit, the operation image configured to be operated for returning display on the display unit to the piece of the process information corresponding to the latest step.

7. The information processing device according to claim 1, wherein
the process information includes an amount of carbon dioxide discharged in each step of the process, and
the display control unit is configured to display at least one of
the amount of carbon dioxide discharged in each step of the process, and
a total amount of carbon dioxide discharged through the process up to a latest step.

8. The information processing device according to claim 1, wherein
the process information displayed on the display unit includes a branch from which processes selectable by a user originate.

9. The information processing device according to claim 1, wherein
the display control unit is configured to displays an operation image on the display unit based on the display control unit displaying a piece of the process information related to transport on the display unit, the operation image configured to be operated for displaying an image indicating a transport route.

10. The information processing device according to claim 1, wherein
a manner of the user operation for transitioning the display of the process information is changeable.

11. A manufacturing history display system comprising:
a server configured to store manufacturing history information in which multiple pieces of process information are stored in time series, the multiple pieces of the process information indicating steps of a process related to manufacture of a product; and
an information processing device configured to
read attachment information attached to the product, the attachment information being associated with the manufacturing history information
acquire the manufacturing history information associated with the attachment information from the server based on reading of the attachment information, and
display the manufacturing history information on a display unit, wherein
the information processing device is configured to
display one piece of the process information included in the manufacturing history information acquired from the server on the display unit, and
transition the process information displayed on the display unit in a time series in response to a user operation.

12. A manufacturing history display method comprising:
reading attachment information attached to a product, the attachment information being associated with manufacturing history information of the product;
acquiring the manufacturing history information associated with the attachment information from a server based on the reading of the attachment information; and
displaying the manufacturing history information on a display unit based on the acquiring, wherein
the manufacturing history information is information in which multiple pieces of process information are stored in time series, the multiple pieces of the process information indicating steps of a process related to manufacture of the product, and
the displaying includes
displaying one piece of the process information included in the manufacturing history information on the display unit, and
transitioning the process information displayed on the display unit in a time series in response to a user operation.

13. A non-transitory computer readable medium storing a manufacturing history display program comprising instructions configured to, when executed by a computer, cause the computer to perform:
reading attachment information attached to a product, the attachment information being associated with manufacturing history information of the product;
acquiring the manufacturing history information associated with the attachment information from a server based on the reading of the attachment information; and
displaying the manufacturing history information on a display unit based on the acquiring of the manufacturing history information, wherein
the manufacturing history information is information in which multiple pieces of process information are stored in time series, the multiple pieces of the process information indicating steps of a process related to manufacture of the product, and
the displaying includes
displaying one piece of the process information included in the manufacturing history information on the display unit, and
transitioning the process information displayed on the display unit in a time series in response to a user operation.
